(19) United States
(12) Patent Application Publication
(10) Pub. No.: US 2021/0291494 A1
(43) Pub. Date: Sep. 23, 2021

(54) REDRAWN GLASS HAVING ENHANCED PUNCTURE RESISTANCE

(71) Applicant: CORNING INCORPORATED, CORNING, NY (US)

(72) Inventors: Bethany Jon Alderman, Bath, NY (US); Patrick Joseph Cimo, Corning, NY (US); Kuan-Ting Kuo, Chubei (TW); Robert Lee Smith, III, Horseheads, NY (US)

(21) Appl. No.: 17/260,333

(22) PCT Filed: Jul. 9, 2019
(86) PCT No.: PCT/US2019/040948

§ 371 Date: Jan. 14, 2021

Related U.S. Application Data
(60) Provisional application No. 62/699,210, filed on Jul. 17, 2018.

(51) Int. Cl. B32B 17/10; B32B 7/12; B32B 27/36; C03B 23/037; B32B 37/12

(52) U.S. Cl. CPC B32B 17/10128; C03C 15/00; B32B 17/10018; B32B 17/10779; B32B 27/36; C03B 23/037; B32B 17/10981; B32B 17/10935; B32B 37/12; B32B 2307/538; B32B 2307/558; B32B 2457/20; B32B 2571/00; B32B 2310/0418; B32B 2315/08; B32B 2367/00; B32B 17/10146; B32B 7/12

(57) ABSTRACT

A cover element for an electronic device that includes a redrawn glass element, first and second primary surfaces, and a polymeric layer disposed over the first primary surface. The redrawn glass element has a reduced thickness and an average surface roughness of 1 nanometer or less. Further, the cover element can withstand a pen drop height of greater than 6 centimeters or 2.5 times or more than that of a control pen drop height of the cover element having a non-redrawn glass element the layer according to Drop Test 1.

### CROSS-REFERENCE TO RELATED APPLICATION

This application claims the benefit of priority under 35 U.S.C. § 119 of U.S. Provisional Application Ser. No. 62/699,210 filed on Jul. 17, 2018, the content of which is relied upon and incorporated herein by reference in its entirety.

### TECHNICAL FIELD

The disclosure generally relates to redrawn glass articles, elements and layers, and various methods for making them. More particularly, the disclosure relates to puncture-resistant versions of these components and methods for making them.

### BACKGROUND

Thin versions of glass products and components for device applications are becoming increasingly more desirable. For example, glass has been used as a cover for electronic devices for many years to protect displays and touch sensors from damage. To assist in apparatus design changes and reduce weight of electronic devices, the industry is more frequently using glass of reduced thickness.

Some of these electronic devices also can make use of flexible displays. Optical transparency and thermal stability are often desirable properties for flexible display applications. In addition, flexible displays should have high fatigue and puncture resistance, including resistance to failure at small bend radii, particularly for flexible displays that have touch screen functionality and/or can be folded.

Conventional flexible glass materials offer many beneficial properties for flexible substrate and/or display applications. However, efforts to harness glass materials for these applications have been largely unsuccessful to date. Generally, glass substrates can be manufactured to very low thicknesses (<25 μm) to achieve smaller and smaller bend radii. These “thin” glass substrates suffer from limited puncture resistance. At the same time, thicker glass substrates (>150 μm) can be fabricated with better puncture resistance, but these substrates lack suitable fatigue resistance and mechanical reliability upon bending.

Thus, there is a need for improved electronic device assemblies, and glass cover elements for these assemblies, for reliable use in flexible substrate and/or display applications and functions, particularly for flexible electronic device applications.

### SUMMARY

In a first aspect, there is a cover element that includes a redrawn glass element having a thickness from about 25 μm to about 125 μm and an average surface roughness (Ra) of equal to 1 nm or less, the redraw glass element further having a first primary surface, a second primary surface, and a polymeric layer with a thickness from about 25 μm to about 125 μm and disposed over the first primary surface of the redrawn glass element, wherein the redrawn glass element of the cover element can withstand a pen drop height of greater than 6 cm, wherein the pen drop heights are measured according to Drop Test 1.

In some examples of aspect 1, the redrawn glass element can withstand a pen drop height of greater than 8 cm, greater than 10 cm or greater than 14 cm.

In another example of aspect 1, the redrawn glass element has a thickness from about 50 μm to about 75 μm.

In another example of aspect 1, the average surface roughness (Ra) of the redrawn glass element is 0.7 nm or less or 0.4 nm or less.

In another example of aspect 1, the polymeric layer contains a polyimide, a polyethylene terephthalate, a polycarbonate or a poly methyl methacrylate.

In another example of aspect 1, the polymeric layer is coupled to the redraw glass element by an adhesive, wherein the adhesive is in direct contact with the redrawn glass element and the polymeric layer.

In another example of aspect 1, the cover element is further in combination with an electronic device.

In a second aspect, there is a method of making a cover element assembly, the method includes forming a redrawn glass sheet element by redrawing a glass sheet, for example a fusion drawn glass sheet, the redrawn glass sheet element having a first primary surface, a second primary surface, a final thickness from about 25 μm to about 125 μm and a final average surface roughness (Ra) of equal to 1 nm or less, disposing a polymeric layer over the first primary surface of the redrawn glass sheet element, the polymeric layer has a thickness from about 25 μm to about 125 μm, and wherein the redrawn glass element of the cover element can withstand a pen drop height of greater than 6 cm, wherein the pen drop heights are measured according to Drop Test 1.

In an example of aspect 2, the glass sheet has a thickness from about 250 μm to about 750 μm prior to redrawing to form the redrawn glass sheet element.

In another example of aspect 2, the glass sheet is fed into a redraw furnace, the glass sheet is heated in the redrawn furnace to have a viscosity from about 100,000 poise to about 10,000,000 poise and is drawn to the final thickness from about 25 μm to about 125 μm to form the redrawn glass sheet element.

In another example of aspect 2, the average surface roughness (Ra) of the redrawn glass sheet element is from about 0.1 nm to about 0.7 nm.

In another example of aspect 2, the redrawn glass sheet element has a thickness from about 50 μm to about 75 μm.

In another example of aspect 2, the redrawn glass sheet element can withstand a pen drop height of greater than 10 cm.

In another example of aspect 2, the redrawn glass sheet element can withstand a pen drop height of about 10 cm to about 16 cm.

In another example of aspect 2, the polymeric layer includes a polyimide, a polyethylene terephthalate, a polycarbonate or a poly methyl methacrylate.

In another example of aspect 2, the polymeric layer is coupled to the redrawn glass sheet element by an adhesive, wherein the adhesive is in direct contact with the redrawn glass sheet element and the polymeric layer.

In another example of aspect 2, the method further includes cutting the redrawn glass sheet element into separate redrawn glass sheet parts prior to disposing the polymeric layer over the primary surface of the redrawn glass sheet element.

Any one of the above aspects (or examples of those aspects) may be provided alone or in combination with any one or more of the examples of that aspect discussed above; e.g., the first aspect may be provided alone or in combination with any one or more of the examples of the first aspect discussed above; and the second aspect may be provided alone or in combination with any one or more of the examples of the second aspect discussed above; and so-forth.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments. Directional terms as used herein—for example, up, down, right, left, front, back, top, bottom—are made only with reference to the figures as drawn and are not intended to imply absolute orientation.

### BRIEF DESCRIPTION OF THE DRAWINGS

FIG. 1 is a flow chart of a method of forming redrawn glass and chemical thinned glass according to an aspect of this disclosure.

FIG. 2 is a cross-sectional view of a stack assembly including a redrawn glass layer according to an aspect of this disclosure.

FIG. 3 is a cross-sectional view of a stack assembly including a redrawn glass layer according to an aspect of this disclosure.

FIG. 4 is a plot of pen-drop failure height of various different glass samples according to an aspect of this disclosure.

FIG. 5 is a Weibull plot of failure probability vs. strength under two point bending of various different glass samples after cube corner contact according to an aspect of this disclosure.

FIG. 6A is a surface image of a sample glass according to aspects of the disclosure.

FIG. 6B is a surface image of a sample glass according to aspects of the disclosure.

FIG. 7 is a surface image of a sample glass according to aspects of the disclosure.

### DETAILED DESCRIPTION

Reference will now be made in detail to embodiments, examples of which are illustrated in the accompanying drawings. Whenever possible, the same reference numerals will be used throughout the drawings to refer to the same or like parts. Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. Whether or not a numerical value or end-point of a range in the specification recites “about,” the numerical value or end-point of a range is intended to include two embodiments: one modified by “about,” and one not modified by “about.” It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

Among other features and benefits, the cover elements for electronic devices and electronic device assemblies (and the methods of making them) of the present disclosure provide mechanical reliability (e.g., in static tension and fatigue) upon bending, and high puncture and impact resistance. The puncture and impact resistance are particularly beneficial when the cover elements and electronic device assemblies are used in displays, for example, a foldable display.

For example, the cover element and/or electronic device assembly may be used as one or more of: a cover on the user-facing portion of a display (e.g., a foldable display), a location wherein puncture and impact resistance are particularly desirable; a substrate, disposed internally within the device itself, on which electronic components are disposed; or elsewhere in a display device. Alternatively, the cover element and/or electronic device assembly may be used in a device not having a display, but one wherein a glass layer is used for its beneficial properties. The puncture and impact resistance is specifically beneficial when the cover element and/or electronic device assembly is used on an exterior portion of the device, wherein the exterior is exposed to the environment or to a user who will interact with it and the cover element contains a thin redrawn glass element as described in the present disclosure.

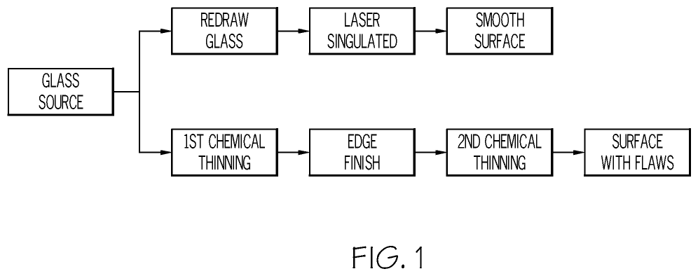

Preparing the redrawn glass element can follow, for example, the process of heating and drawing a glass preform material to the desired thickness to form the redrawn glass element. FIG. 1 shows a flow chart of an example method for forming a redrawn glass element (top boxes), and an alternative method for forming a chemically thinned or etched glass (bottom boxes). As shown, the redraw method, a more efficient method, includes fewer processing and handling steps as compared to the chemical thinning method. Each method shown in FIG. 1 starts with a starting glass material (Glass Source), for example, a fusion drawn glass. In the redraw process, the glass material is heated and then redrawn to reduce the thickness of the glass material, which can be greater than 500 micrometers (μm, or microns), to the desired thickness, for example, below 200 μm or in the range of 25 μm to 125 μm. The redrawn thinned glass can be singulated (for example Laser Singulated) or cut to arrive at glass samples having a predetermined shape and dimensions (e.g., redrawn glass cover element). The singulated glass samples can be separate redrawn glass sheet parts for use in preparing a cover element, for example, the redrawn glass element of a cover element for an electronic device. The thinned glass can be singulated by, for example, mechanical score and break, or laser cutting. This process results in glass substrates having a smooth surface (Smooth Surface).

In the chemical thinning method of FIG. 1, the glass source material is chemically thinned in a first step (1^{st} Chemical Thinning) to a desired thickness, for instance, about 200 μm. The chemically thinned glass is optionally singulated by a conventional method as noted above. The edges of the chemically thinned glass or singulated glass pieces are finished (Edge Finish) to reduce flaws on the edges for improved strength, for example, bend strength. Edge finishing can be achieved by standard methods, for example, acid edge etching or mechanical finishing or polishing. The edge finished singulated glass pieces are further chemically thinned, in a second thinning step (2^{nd} Chemical Thinning), to a final desired thickness below 200 μm. By controlling etching time and/or etching solution concentration, a desired final thickness can be achieved. An example etching rate using an acid etching solution (e.g., a hydrochloric or hydrofluoric acid etch solution) is about 1 to 2 μm removal per minute. This process is more likely to result in glass substrates having surfaces that potentially have flaws (Surface with Flaws).

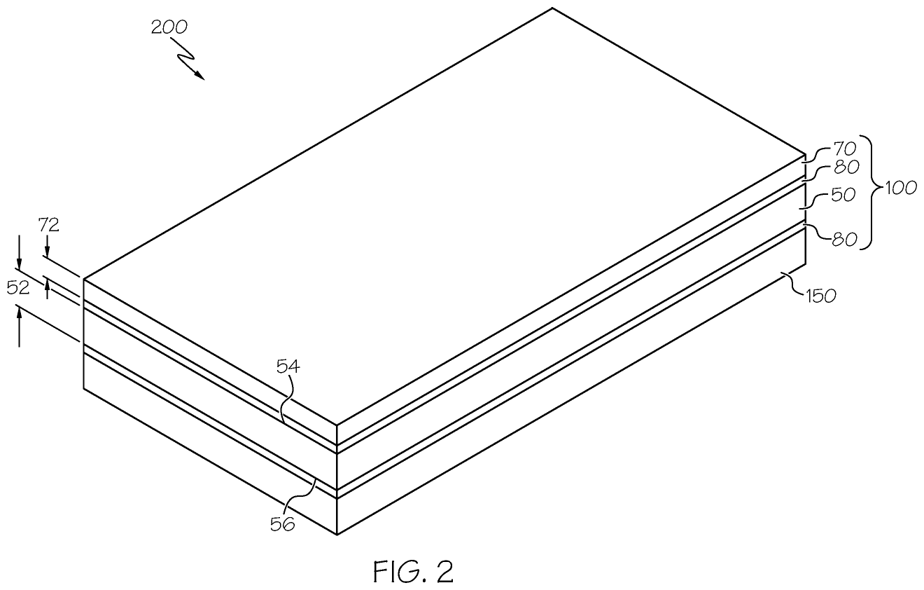

Redrawn glass is used throughout this disclosure as the glass element in cover elements for use with electronic device assemblies. Referring to FIG. 2, an electronic device assembly 200, or portion thereof, is depicted that includes an electronic device substrate 150 and a multilayer cover element 100 disposed over and directly adhered to the substrate 150. The cover element 100 includes a glass element or layer 50. Glass element 50 has a thickness 52, a first primary surface 54 and a second primary surface 56. In addition, the cover element 100 also includes a polymeric layer 70, with a thickness 72, disposed over the first primary surface 54 of the glass element 50.

With further regard to the glass element 50, the thickness 52 can range from about 25 μm to about 200 μm in some embodiments. In other embodiments, thickness 52 can range from about 25 μm to about 150 μm, from about 50 μm to about 125 μm, or about 60 μm to about 100 μm, or about 70 μm, 75 μm or 80 μm, including any ranges and subranges therebetween. In cover element 100 (or glass article), an increase in thickness 52 of the glass element 50 can provide additional puncture resistance for the majority of the cover element 50.

In the embodiments of the electronic device assembly 200 and the cover element 100 depicted in FIG. 2, the glass element 50 includes one glass layer. In other embodiments, glass element 50 can include two or more glass layers, for example, two or more glass layers directly bonded to one another.

Further, as used herein the term “glass” is meant to include any material made at least partially of glass, including glass and glass-ceramics. “Glass-ceramics” include materials produced through controlled crystallization of glass. In embodiments, glass-ceramics have about 30% to about 90% crystallinity. Non-limiting examples of glass ceramic systems that may be used include Li₂O×Al₂O₃×nSiO₂ (i.e., an LAS system), MgO×Al₂O₃×nSiO₂ (i.e., a MAS system), and ZnO×Al₂O₃×nSiO₂ (i.e., a ZAS system).

In some embodiments, for example in FIG. 2, glass element 50 can be fabricated from alkali-free aluminosilicate, borosilicate, boroaluminosilicate, and silicate glass compositions. Glass element 50 can also be fabricated from alkali-containing aluminosilicate, borosilicate, boroaluminosilicate, and silicate glass compositions. In certain embodiments, alkaline earth modifiers can be added to any of the foregoing compositions for glass element 50. In some embodiments, glass compositions according to the following are suitable for the glass element 50: SiO₂ at 64 to 69% (by mol %); Al₂O₃ at 5 to 12%; B₂O₃ at 8 to 23%; MgO at 0.5 to 2.5%; CaO at 1 to 9%; SrO at 0 to 5%; BaO at 0 to 5%; SnO₂ at 0.1 to 0.4%; ZrO₂ at 0 to 0.1%; and Na₂O at 0 to 1%. In some embodiments, the following composition is suitable for the glass element 50: SiO₂ at −67.4% (by mol %); Al₂O₃ at −12.7%; B₂O₃ at −3.7%; MgO at −2.4%; CaO at 0%; SrO at 0%; SnO₂ at −0.1%; and Na₂O at −13.7%. In some embodiments, the following composition, by mol %, is also suitable for the glass element 50: SiO₂ at 68.9%; Al₂O₃ at 10.3%; Na₂O at 15.2%; MgO at 5.4%; and SnO₂ at 0.2%. In some embodiments, a composition for glass element 50 is selected with a relatively low elastic modulus (compared to other alternative glasses). The elastic modulus in the glass element 50 can reduce the tensile stress in the element 50 during use, for instance, bending or flexing of an electronic display device. Other criteria can be used to select the composition for glass element 50, including but not limited to, ease of manufacturing to low thickness while minimizing the incorporation of flaws, ease of development of a potential compressive stress region to offset tensile stresses generated during bending, optical transparency, and/or corrosion resistance. The use of a redrawn glass element 50 selectively achieves the above criteria.

The glass element 50 can adopt a variety of physical forms and shapes for use in electronic devices. From a cross-sectional perspective, the element 50 and the layer (or layers) can be flat or planar sheet parts. In some embodiments, element 50 can be fabricated in non-rectilinear, sheet-like forms depending on the final application. As an example, a mobile display device having an elliptical display and bezel could include a glass element 50 having a generally elliptical, sheet-like form.

The glass element or element 50 as described herein is a redrawn glass layer. Redrawn glass advantageously provides an efficient process to form thin glass with improved surface quality and properties as compared to the same glass material at the same thickness that is prepared by other manufacturing processes, for example, a chemical thinning or etching process, that includes more processing steps than a redraw process as shown in FIG. 1. In some embodiments, the redrawn glass layer has an equivalent or improved bend strength to glass layers made by other processes, but also unexpectedly exhibits significantly improved impact resistance properties as compared to non-redrawn glass (e.g., chemically thinned glass) of the same or substantially the same thickness.

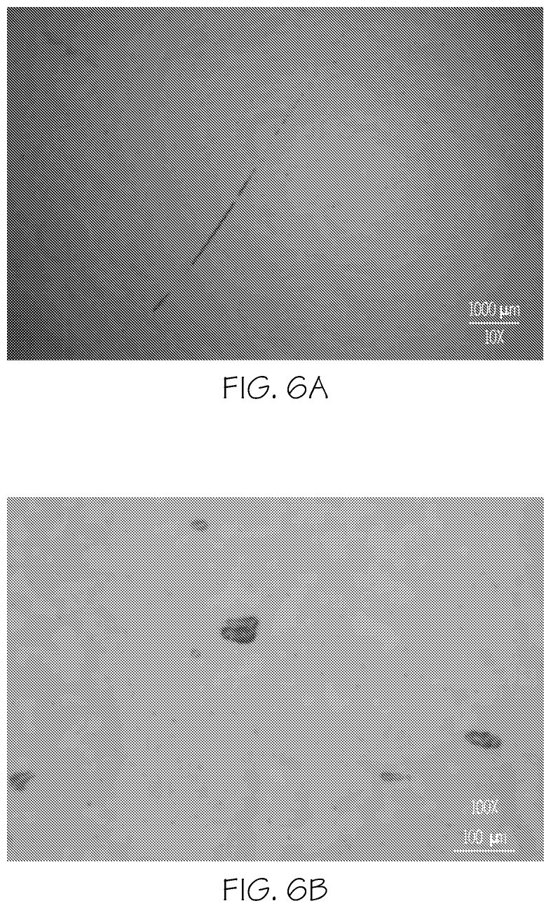

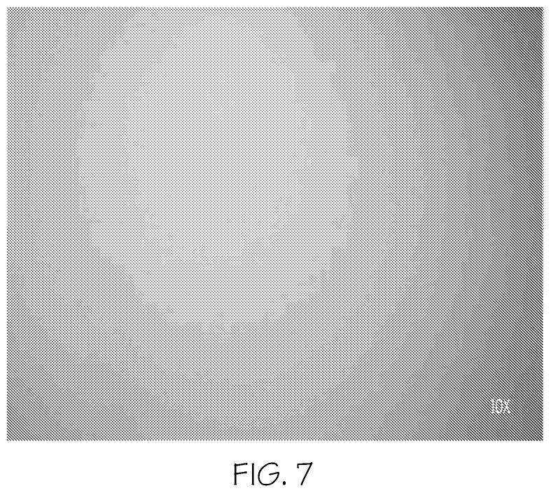

The redrawn glass can be formed by drawing a base glass material or preform (e.g., a fusion drawn glass) with rollers (touching a non-quality area, or edge, of the glass) under heating conditions to thin the base glass material to the desired thickness in one redraw step. Example redraw methods are, for instance, as disclosed in WO 2017/095791. The redrawn glass element preferably contains fewer surface flaws, for example, scratches, depressions or pits, as compared to glass elements formed by thinning processes other than a redraw process, such as a chemical etching process. For example, the smooth, pristine surface of a redrawn glass sample, as compared to the surface of glass samples prepared by a chemical etching process, are shown in FIGS. 6A, 6B and 7. FIG. 6A shows a magnified surface image of a singulated glass sheet part having a scratch flaw after being thinned by a 2-step chemical etching process. Similarly, FIG. 6B shows a magnified surface image of a singulated glass sheet part having etching pit flaws after being thinned by a 2-step chemical etching process. In contrast, FIG. 7 shows a magnified surface image of a singulated glass sheet part having a pristine, smooth surface without scratches, depressions or etching pits as shown in the chemically thinned glass images. The redrawn glass sheet shown in FIG. 7 was formed by redrawing a fusion drawn glass material, wherein no chemical etching process was used to achieve the thinned part.

In other embodiments, the redrawn glass element 50 can have a smooth surface with reduced surface roughness as compared to glass elements formed by thinning processes other than a redraw process, such as a chemical etching process. For example, as shown in Table 1, the smooth surface of a redrawn glass sample, as compared to the surface of glass samples prepared by a chemical etching process. In some embodiments, the redraw glass element 50 can have an average surface roughness (Ra) in the range from about 0.1 nanometers (nm) to about 2 nm, about 0.15 nm to about 1 nm, about 0.2 nm to about 0.9 nm, or about 0.25 nm or less, about 0.3 nm or less, about 0.4 nm or less, about 0.5 nm or less, about 0.6 nm or less, about 0.7 nm or less, or about 0.8 nm or less, including any ranges and subranges therebetween.

Referring again to FIG. 2, the electronic device assembly 200 and the cover element 100 include a polymeric layer 70 having thickness 72. In the configuration shown, the polymeric layer 70 is disposed over the first primary surface 54 of the glass element 50. For example, the polymeric layer 70 can be disposed directly on and in contact with the first primary surface 54 of the glass element in some embodiments. Direct contact of the glass element 50 and polymer layer 70 can include the entire facing surfaces of both layers being in uniform contact with one another. In other embodiments, the contact between the glass element 50 and polymer layer 70 can include less than the entire facing surfaces of both layers.

In other embodiments, as depicted in exemplary form in FIG. 2, the polymeric layer 70 can be adhered to the glass element 50 with an adhesive 80. The adhesive 80 can be uniformly applied and in contact with the entire surface of both the glass element 50 and the polymeric 70 layer. In other embodiments, the contact between the glass element 50 and polymer layer 70 can include less than the entire facing surfaces of both layers.

The thickness 72 of the polymeric layer 70 can be set at about 1 micrometer (μm) to about 200 μm in some embodiments. In other embodiments, the thickness 72 of the polymeric layer 70 can be set from about 5 μm to about 190 μm, or from about 10 μm to about 180 μm, or from about 10 μm to about 175 μm, or from about 15 μm to about 170 μm, or from about 20 μm to about 160 μm, or from about 25 μm to about 150 μm, or from about 30 μm to about 140 μm, or from about 35 μm to about 130 μm, or from about 35 μm to about 125 μm, or from about 40 μm to about 120 μm, or from about 45 μm to about 110 μm, or from about 50 μm to about 100 μm, or from about 55 μm to about 90 μm, or from about 60 μm to about 80 μm, or from about 60 μm to about 75 μm, and all ranges and sub-ranges between the foregoing values.

According to some embodiments, the polymeric layer 70 can have a low coefficient of friction so as to allow sliding contact without damage. In these configurations, the polymeric layer 70 is disposed on the first primary surface 54 of the glass element 50. When employed in the cover elements and electronic devices of the present disclosure, the polymeric layer 70 can function to reduce friction and/or reduce surface damage from abrasion. The polymeric layer 70 can also provide a measure of safety in retaining pieces and shards of glass element 50 when the element and/or layer has been subjected to stresses in excess of its design limitations that cause failure. The thickness 72 of the polymeric layer 70 can be set at 1 μm or less in some aspects. In other aspects, the thickness 72 of the polymeric layer 70 can be set at 500 nm or less, or as low as 10 nm or less for certain compositions. Further, in some aspects of the electronic device assembly 200 and the cover element 100, the polymeric layer 70 can be employed on the primary surface 56 to provide a safety benefit in retaining shards of glass element 50 that have resulted from stresses exceeding the design conditions of the glass element 50. The polymeric layer 70 on the primary surface 56 may also provide increased puncture resistance to the cover element 100. Not wishing to be bound by theory, the polymeric layer 70 may have energy absorbing and/or dissipating and/or distributing characteristics that allow the cover element 100 to take a load that it would otherwise not be able to withstand without the polymeric layer 70. The load may be either static or dynamic, and may be applied on the side of the cover element 100 having the polymeric layer 70.

As deployed in an electronic device assembly 200 and the cover element 100 depicted in FIG. 2, the polymeric layer 70, according to some embodiments, can provide a measure of safety in retaining pieces and shards of the glass element 50 if the element and/or layer is subjected to stresses exceeding its design limitations that cause failure, as configured within the device assembly 200 and cover element 100. Further, in some embodiments of the electronic device assembly 200 and cover element 100, an additional polymeric layer 70 (not shown) can be employed on the second primary surface 56 of the glass element 50 to provide an additional safety benefit by retaining shards of glass element 50 (i.e., as located on or in proximity to the second primary surface 56) that have resulted from stresses exceeding their design conditions.

The presence of the polymeric layer 70 in the cover element 100 can ensure that objects and other instrumentalities that might otherwise directly impact the glass element 50 are impacted against the polymeric layer 70. This can reduce the likelihood of developing impact-related flaws in the glass element 50 that might otherwise reduce its strength in static and/or cyclic bending. Still further, the presence of the polymeric layer 70 also can spread a stress field from an impact over a larger area of the underlying glass element 50 and any electronic device substrate 150, if present. In some embodiments, the presence of the polymeric layer 70 can reduce the likelihood of damage to electronic components, display features, pixels and the like contained within an electronic device substrate 150.

According to some embodiments, the electronic device assembly 200 and/or cover element 100 depicted in FIG. 2 (i.e., as including the polymeric layer 70) can withstand greater pen drop heights in comparison to a comparative electronic device assembly 200 and/or cover element 100 with or without a polymeric layer, such as polymeric layer 70, wherein the comparable cover element 100 includes a non-redrawn glass layer, for example, a glass layer that was thinned by chemical etching, of the same material and thickness. More particularly, these pen drop heights can be measured according to a Drop Test 1. As described and referred to herein, Drop Test 1 is conducted such that samples of the cover element or electronic device assembly are tested with the load (i.e., from a pen dropping at a certain height) imparted to the exposed glass surface or side of the redrawn glass element (e.g., glass element 50) opposite the polymeric layer 70 thereon adhered with an adhesive (when such layer was part of the stack), with the opposite side of the cover element or device assembly being supported by an aluminum plate. No tape is used on the side of the polymer layer resting on the aluminum plate. The exposed glass surface of the redrawn glass element of Drop Test 1 does not include an additional layer overlying the glass surface, for example, a protective or polymer layer.

One tube is used according to Drop Test 1 to guide the pen to the sample, and the tube is placed in contact with the top exposed glass surface of the sample so that the longitudinal axis of the tube is substantially perpendicular to the top surface (exposed glass element surface) of the sample. The tube has an outside diameter of 2.54 centimeters (cm), an inside diameter of 1.4 cm and a length of 90 cm. An acrylonitrile butadiene (“ABS”) shim is employed to hold the pen at a desired height for each test (except for tests conducted at 90 cm, as no shim was used for this height). After each drop, the tube is relocated relative to the sample to guide the pen to a different impact location on the sample. The pen employed in Drop Test 1 is a BIC® Easy Glide Pen, Fine, having a tungsten carbide, ball point tip of 0.7 millimeters (mm) diameter, and a weight of 5.73 grams (g) as including the cap (4.68 g without the cap). According to Drop Test 1, the pen is dropped with the cap attached to the top end (i.e., the end opposite the tip) so that the ball point can interact with the test sample. In a drop sequence according to Drop Test 1, a first pen drop is conducted at an initial height of 1 cm, followed by successive drops in 1 cm increments to a maximum pen drop height of 90 cm. Further, after each drop is conducted, the presence of any observable fracture, failure or other evidence of damage to the electronic device assembly or cover element is recorded along with the particular pen drop height. More particularly, with regard to the device assemblies and cover elements of the disclosure, pen drop heights are recorded based on observed damage to the glass element (wherein damage is cracking), polymer layer (wherein damage is dimpling) and/or OLED-containing substrate (wherein damage is failure of one or more areas to light as intended). Under Drop Test 1, multiple samples can be tested according to the same drop sequence to generate a population with improved statistics. Also according to Drop Test 1, the pen is changed to a new pen after every 5 drops, and for each new sample tested. In addition, all pen drops are conducted at random locations on the sample at or near the center of the sample, with no pen drops near or on the edge of the samples.

According to some embodiments, the redrawn glass element of the electronic device assembly 200 and/or cover element 100 depicted in FIG. 2 (i.e., as including the polymeric layer 70) can withstand a pen drop height of greater than about 5 times, greater than about 4.5 times, greater than about 4 times, greater than about 3.5 times, greater than about 3 times or greater than about 2.5 times that of a control pen drop height associated with a comparative electronic device assembly 200 and/or cover element 100 with or without a polymeric layer, such as polymeric layer 70, wherein the comparative assembly 200 and/or cover element 100 does not include a redrawn glass layer, but rather a non-redrawn glass layer of similar or same thickness and composition, in which all pen drop heights are measured according to Drop Test 1 outlined herein.

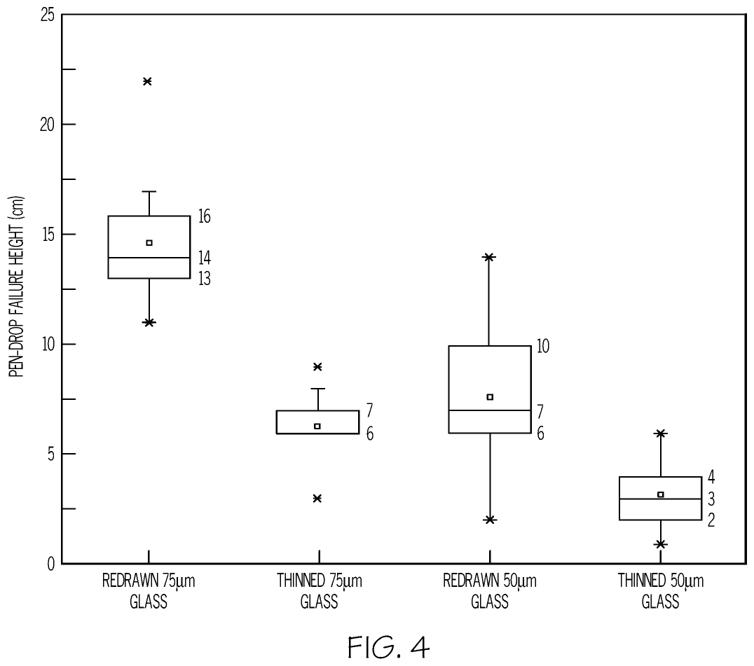

Further, in some embodiments, as depicted in the graph of FIG. 4, the redrawn glass element of an electronic device assembly 200 and/or a cover element 100 can withstand a pen drop height of greater than about 5 cm, for example greater than about 6 cm, greater than about 7 cm, greater than about 8 cm, greater than about 9 cm, greater than about 10 cm, greater than about 11 cm, greater than about 12 cm, greater than about 13 cm, greater than about 14 cm, greater than about 15 cm, greater than about 16 cm, greater than about 17 cm or greater than about 18 cm, and all pen drop heights between these levels, as measured according to Drop Test 1 described herein. For example, a 50 μm thick redrawn glass element can withstand a pen drop height of greater than 6 cm, for example 7 cm or more, or 10 cm or more. For example, a 75 μm thick redrawn glass element can withstand a pen drop height of greater than 10 cm, for example 13 cm or more, 14 cm or more, or 16 cm or more.

According to some embodiments, the polymeric layer 70 can employ any of a variety of energy-resistant polymeric materials. In some embodiments, the polymeric layer 70 is selected with a polymeric composition having a high optical transmissivity (for example greater than about 88% over the visible wavelengths), particularly when the electronic device assembly 200 or the cover element 100 including the layer 70 is employed in a display device or related application. According to some embodiments, the polymeric layer 70 comprises a polyimide (“PI”), a polyethylene terephthalate (“PET”), a polycarbonate (“PC”) or a poly methyl methacrylate (“PMMA”). The layer 70, in some embodiments, can also be coupled to the glass element 50 by an adhesive 80 (e.g., OCA), as shown in FIG. 2.

According to some embodiments, the polymeric layer 70 can employ various fluorocarbon materials that have low surface energy, including thermoplastics for example, polytetrafluoroethylene (“PTFE”), fluorinated ethylene propylene (“FEP”), polyvinylidene fluoride (“PVDF”), and amorphous fluorocarbons (e.g., DuPont® Teflon® AF and Asahi® Cytop® coatings) which typically rely on mechanical interlocking mechanisms for adhesion. Polymeric layer 70 can also be fabricated from silane-containing preparations, for example, Dow Corning® 2634 coating or other fluoro- or perfluorosilanes (e.g., alkylsilanes) which can be deposited as a monolayer or a multilayer. In some aspects, layer 70 can include silicone resins, waxes, polyethylene (oxided), PET, polycarbonate (PC), PC with hard coat (HC) thereon, polyimide (PI), PI with HC, or adhesive tape (for example, 3M® code 471 adhesive tape), used by themselves or in conjunction with a hot-end coating for example, tin oxide, or vapor-deposited coatings for example, parylene and diamond-like coatings (“DLCs”). Polymeric layer 70 can also include zinc oxide, molybdenum disulfide, tungsten disulfide, hexagonal boron nitride, or aluminum magnesium boride that can be used either alone or as an additive in the foregoing coating compositions and preparations.

Still further, the polymeric layer 70 may be applied directly to the glass element 50 (as when the material of layer 70 is applied as a liquid, for example), may be placed atop the glass element 50 (as when the material of layer 70 is in the form of a sheet or film, for example), or may be bound to the glass element 50 using an adhesive (e.g., adhesive 80), for example. When present, the adhesive 80, for example, as a single layer, may be optically clear, pressure sensitive, or combinations thereof. The adhesive layer 80 can be in direct and uniform contact with both the glass element 50 and polymer layer 70.

Alternatively or in addition to the above, the polymeric layer 70 may include various other attributes, such as anti-microbial, anti-splinter, anti-smudge, and anti-fingerprint characteristics. Moreover, the polymeric layer 70 may be made of more than one layer, or may be made of different materials within one layer, to provide a variety of functions for the electronic device assembly 200 and/or the cover element 100.

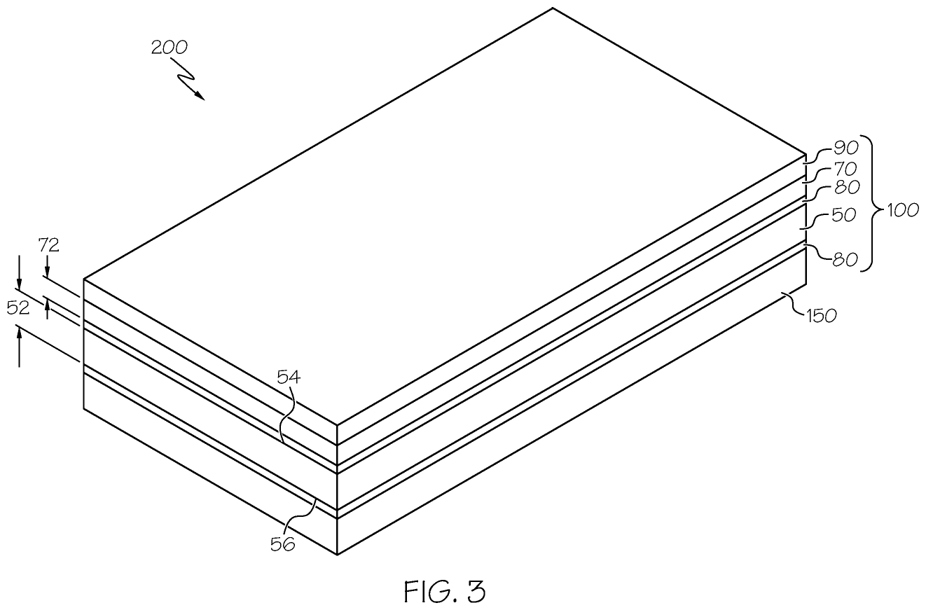

According to some embodiments, as shown in FIG. 3, the electronic device assembly 200 and the cover element 100 depicted in FIG. 2 may include a scratch-resistant coating 90 disposed over the polymeric layer 70. The coating 90 can be configured with a thickness 92, set to 1 μm or less in some embodiments. In other embodiments, the thickness 92 of the coating 90 can be set at 500 nanometers (nm) or less, or as low as 10 nm or less, and all ranges and sub-ranges between the foregoing values, for certain compositions of the coating 90. In other embodiments, the coating 90 has a thickness 92 that ranges from about 1 μm to about 100 μm, including all thickness levels between these bounds. More generally, the scratch-resistant coating 90 can serve to provide additional scratch-resistance (e.g., as manifested in increased pencil hardness as tested according to ASTM Test Method D3363 with a load of 750 g or more) for the foldable electronic device assembly 200 and cover element 100 employing it. Moreover, the scratch-resistant coating 90 can also enhance the impact resistance of the foldable electronic device assembly 200 and the cover element 100. The added scratch resistance (and additional impact resistance in some embodiments) can be advantageous for the device assembly 200 and the cover element 100 to ensure that the significant gains in puncture and impact resistance afforded by the polymeric layer 70 are not offset by reduced scratch resistance (e.g., as compared to a device assembly and/or cover element that would otherwise lack the polymeric layer 70).

In some embodiments, the scratch-resistant coating 90 can comprise a silane-containing preparation for example, Dow Corning® 2634 coating or other fluoro- or perfluorosilanes (e.g., alkylsilanes) which can be deposited as a monolayer or a multilayer. Such silane-containing formulations, as used herein, can also be referred to as a hard coating (“HC”), while recognizing that other formulations, as understood in the field of the disclosure, can also constitute a hard coating. In some embodiments, the scratch-resistant coating 90 can include silicone resins, waxes, polyethylene (oxidized), a PET, a polycarbonate (PC), a PC with an HC component, a PI, and a PI with an HC component, or adhesive tape (for example, 3M® code 471 adhesive tape), used by themselves or in conjunction with a hot-end coating for example, tin oxide, or vapor-deposited coatings for example, parylene and diamond-like coatings (“DLCs”).

Still further, the scratch-resistant coating 90 may also include a surface layer with other functional properties, including, for example, additional fluorocarbon materials that have low surface energy, including thermoplastics for example, polytetrafluoroethylene (“PTFE”), fluorinated ethylene propylene (“FEP”), polyvinylidene fluoride (“PVDF”), and amorphous fluorocarbons (e.g., DuPont® Teflon® AF and Asahi® Cytop® coatings) which typically rely on mechanical interlocking mechanisms for adhesion. In some additional embodiments, the scratch-resistant coating 90 can include zinc oxide, molybdenum disulfide, tungsten disulfide, hexagonal boron nitride, or aluminum magnesium boride that can be used either alone or as an additive in the foregoing coating compositions and preparations.

In certain embodiments of the electronic device assembly 200 and the cover element 100 depicted in FIG. 3, the scratch-resistant coating 90 has a pencil hardness of 5H or more (as measured according to ASTM Test Method D3363 with a load of 750 g or more). According to some embodiments, the scratch-resistant coating 90 can exhibit a pencil hardness of 6H, 7H, 8H, 9H or more, and all values between these hardness levels as measured according to ASTM Test Method D3363.

According to certain embodiments of the electronic device assembly 200 and the cover element 100 depicted in FIGS. 2 and 3, one or more adhesives 80 may be employed between the polymeric layer 70 and the glass element 50, and/or between the electronic device substrate 150 and the glass element 50. Preferably, the adhesives 80 are uniformly applied to the entire surface and in direct contact with both surfaces of layers 50, 70 and/or 150. In other embodiments, the adhesives 80 are applied over less than the entire surface of layers 50 and/or 70. Such adhesives can generally range in thickness from about 1 μm to 100 μm, in some embodiments. In other embodiments, the thickness of each adhesive 80 can range from about 10 μm to about 90 μm, from about 20 μm to about 60 μm, or, in some cases, any of the thicknesses from 1 μm to 100 μm, and all ranges and sub-ranges between the foregoing values. In preferred embodiments, particularly for an electronic device assembly 200 and cover element 100 configured for a display-type application, the adhesives 80 are substantially transmissive, such as optically clear adhesives (“OCA”).

In order to promote a further understanding, the following examples are provided. These examples are shown by way of illustration and not limitation.

### EXAMPLES

As demonstrated by the results depicted in FIG. 4, the improved puncture resistance and glass element thickness can be correlated for the present disclosure of a cover element. The results in FIG. 4 were generated by measuring the puncture resistance of various redrawn and chemical etched glass samples having thicknesses including 75 and 50 μm.

Half of the tested glass samples were prepared by first etching 200 μm-thick fusion draw glass to thin the glass to about 100 to 120 μm thickness level using an etching solution having 12.5% HF, 6.5% HNO₃, and 81% deionized water (DI). The etching solution, at 27° C., was sprayed onto the glass surface (top and bottom) to remove glass thickness. The glass was singulated into glass samples and the edges of the samples were mechanically finished to reduce edge flaws. The finished glass samples were further chemically thinned to thicknesses of 50 and 75 μm using an etching solution having 12.5% HF, 6.5% HNO₃, and 81% deionized water (DI).

The other half of the glass samples were prepared by redrawing the 200 μm-thick fusion drawn glass to thin the glass to either a 50 or 75 μm thickness. A redraw process as disclosed in WO 2017/095791, herein incorporated in its entirety, was carried out to thin a fusion drawn glass preform to produce the draw thinned glass samples. Particularly, a fusion drawn glass preform is heated to reach a glass viscosity value in the range of 10⁵ to 10⁷ poise prior to redrawing the preform to the specific target thickness which is controlled by adjusting the mass balance of the redraw process. The fusion drawn preform is fed at a rate of from 3 mm to 100 mm per minute at a pull speed from 50 mm to 1000 mm per minute to arrive at the target thickness. Redrawn glass was cooled at a rate to match the expansion curve of the preform glass through a setting zone to arrive at a viscosity in the range of 10⁹ to 10¹⁵ poise. The thinned glass was singulated into glass samples for testing.

Puncture resistance testing was performed on each glass sample, as laminated to a 100 μm thick PET layer adhered by a 50 μm thick OCA adhesive layer. Once each glass sample (e.g., 50 μm thick glass, 75 μm thick glass) was laminated, the pen drop test discussed here was used. The results from this testing were plotted in FIG. 4.

As the results from FIG. 4 demonstrate, the puncture resistance of the glass samples decreased from an average pen drop height of about 14 cm, or a range of 13 to 16 cm, for 75 μm redrawn glass to an average of about 6.5 cm, or a range of 6 to 7 cm, for 75 μm chemically thinned glass. The 75-μm redrawn glass exhibited an improved puncture resistance of 115 percent or more as compared to 75-μm chemically thinned glass. Likewise, the puncture resistance of the glass samples decreased from an average pen drop height of about 7 cm, or a range of 6 to 10 cm, for 50 μm redrawn glass to an average of about 3 cm, or a range of 2 to 4 cm, for 50 μm chemically thinned glass. The 50-μm redrawn glass exhibited an improved puncture resistance of 130 percent or more as compared to 50-μm chemically thinned glass. In one or more embodiments, a redrawn glass element having a thickness in the range of 25 μm to 125 μm has an increased puncture resistance, as measured according to Drop Test 1, that is greater than a chemically thinned glass element of the same or similar thickness. The increase in puncture resistance can be in the range of 25 percent to 200 percent, 50 percent to 150 percent, or greater than 75 percent, greater than 90 percent, greater than 100 percent, greater than 110 percent, greater than 115 percent, greater than 120 percent, or greater than 125 percent, and all ranges and sub-ranges between the foregoing values.

Further, the puncture resistance, already well above that for chemically thinned glass, significantly increased as the thickness of the redrawn glass increased from 50 μm to 75 μm. For example, the average pen drop height increased from 6.5 cm to 14 cm, about a 115% increase, as thickness of the redrawn glass was raised from 50 μm to 75 μm, a 50% increase. The redrawn glass provides a glass element having an improved puncture resistance that can be further adjusted by varying its thickness.

As evidenced herein the puncture resistance of the tested glass samples was highly dependent not only on how the glass samples were prepared, but also on the glass thickness for redrawn glass samples as compared to chemically thinned glass samples. In addition, FIG. 4 demonstrates that puncture resistance of the glass element 50 can be increased by using redrawn glass as opposed to glass thinned by other methods, for example, chemical thinning. Further, FIG. 4 shows that puncture resistance can be controlled by using redrawn glass of different thicknesses whereas glass thinned by other methods may not result in as significant a change in puncture resistance if thickness is increased. The use of redrawn glass as described in this disclosure provides enhanced puncture resistance with thin glass and provides for a glass source that undergoes less processing and handling steps as compared to chemically thinned glass, which can reduce manufacturing time and costs. Moreover, the improved puncture resistance of the redrawn glass elements can advantageously allow the use of thinner glass to achieve puncture resistance properties that are significantly greater than that of thicker glass elements prepared by a non-redraw method. This can reduce the amount of material used in an electronic device, which can result in lower manufacturing costs and lighter devices.

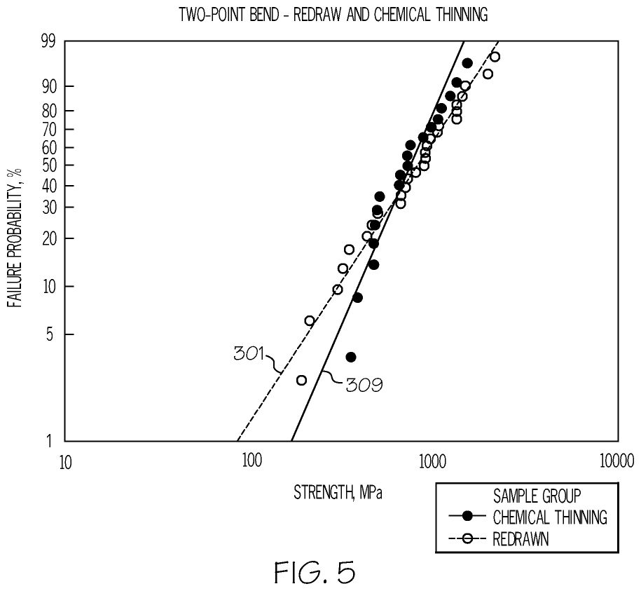

Regarding non-redraw methods, for example a chemical etching process, such processes can leave flaws within the surface of the glass structure. These flaws can propagate and cause glass breakage during the application of stress to the cover element from the application environment and usage. As depicted in FIGS. 6A and 5B, chemically thinning of glass can result in flaws. FIG. 6A is an image of scratches that can result from a chemical thinning process used to prepare a glass element. FIG. 6B depicts etching pits that can result from a chemical thinning process used to prepare a glass sample. In contrast, FIG. 7 shows a pristine, smooth surface of a glass sample made by a redraw process according to the present disclosure. The lack of flaws on the surface of the redrawn glass sample can reduce or eliminate the risk of glass breakage during the application of stresses to the cover element during manufacturing and usage in an electronic device.

An additional benefit of using a redrawn glass element, as opposed a glass element prepared by another method such as chemical thinning, is shown in FIG. 5, which shows various two point bend strength distributions. The two point bend values in these figures were measured by testing the samples as follows. The samples were stressed at a constant rate of 250 MPa/sec. For the two point bending protocol, see S. T. Gulati, J. Westbrook, S. Carley, H. Vepakomma, and T. Ono, “45.2: Two point bending of thin glass substrates,” in SID Conf, 2011, pp. 652-654. The environment was controlled at 50% relative humidity and 25° C. The data sets show stress at failure. Half of the 75 μm thick glass layers tested in the experiment used to generate the data of FIG. 5 were formed by a redraw process and half of the glass layers were formed by a chemical thinning process. The “B” group of glass layers, as denoted by open circle symbols in FIG. 5, consisted of redrawn glass samples. The “A” group of glass layers, as denoted by closed circle symbols in FIG. 5, consisted of chemically thinned glass samples.

Line 301 shows a Weibull distribution for strength of redrawn glass samples that were thinned from 200 μm thick to 75 μm thick. This set of samples shows a strength of about 700 MPa at a 20% failure probability. Line 309 shows a Weibull distribution of strength of chemically thinned glass samples that were deep etched from 200 μm thick to 75 μm thick. These samples show a slightly increased strength, of about 750 MPa at a 20% failure probability. The bend strengths of redrawn and chemically thinned glass samples are similar across a broad range of failure probabilities

As shown in FIG. 5, the use of redrawn glass for glass element 50 can provide the same, and in some instances better, bend strength as compared to glass that is chemically thinned. FIG. 5 shows that redrawn glass provides increased strength at failure probabilities above about 40%. Thus, selection and use of redrawn glass for glass element 50 can provide improved puncture resistance with a material that undergoes less processing and handling steps while also providing similar, and in some instances better, bend strength.

The surface roughness (Ra) of the redrawn and chemically thinned glass samples were measured to demonstrate the improved smoothness of the redrawn glass. Table 1 lists the average surface roughness of both sides of the glass samples as measured by atomic force microscopy.

TABLE 1

| Glass Sample | Ra (nm) (Surface A) | Ra (nm) (Surface B) |
|---|---|---|
| Redrawn - 75 μm | 0.21 | 0.71 |
| Redrawn - 50 μm | 0.37 | 0.36 |
| Chemical Etch - 75 μm | 2.65 | 5.37 |
| Chemical Etch - 50 μm | 0.63 | 0.53 |

As can be seen, the redrawn glass samples have a reduced average surface roughness (Ra) as compared to chemically thinned glass samples of the same thickness. For example, the 75 μm redrawn glass exhibited an average surface roughness (on surface A) of 0.25 nm or less, which represents a surface roughness reduction of greater than 92% as compared to chemically thinned glass at the same thickness (and same surface A). For 50 μm thick glass samples, the redrawn glass exhibited an average surface roughness (on surface A) of 0.40 nm or less, which represents a surface roughness reduction of greater than 41% as compared to chemically thinned glass at the same thickness (and same surface A).

In another example, for the opposite side of the glass samples (Surface B), the 75 μm and 50 μm redrawn glass samples had an average surface roughness of 0.75 or less and 0.40 or less, which represents a surface roughness reduction of greater than 86% and 32%, respectively.

In one or more embodiments, a redrawn glass element having a thickness in the range of 25 μm to 125 μm has a reduced surface roughness, as measured by atomic force microscopy, that is less than a chemically thinned glass element of the same or similar thickness. The reduction in surface roughness can be in the range of 25 percent to 95 percent, or from 30 percent to 90 percent, or greater than 35 percent, or greater than 40 percent, or greater than 45 percent, or greater than 50 percent, or greater than 55 percent, or greater than 60 percent, and all ranges and sub-ranges between the foregoing values.

Many variations and modifications may be made to the above-described embodiments of the disclosure without departing substantially from the spirit and various principles of the disclosure. All such modifications and variations are intended to be included herein within the scope of this disclosure and protected by the following claims.

For example, although in some embodiments the cover element was described as being used as a typical “cover glass” for a display, the cover element may be used on any portion of a device housing, and in some embodiments need not be transparent (as where the cover element is not used in a location where one would view objects there through).

1. A cover element comprising:
a redrawn glass element comprising a thickness from about 25 μm to about 125 μm and an average surface roughness (Ra) of equal to 1 nm or less, the redrawn glass element further comprising a first primary surface, a second primary surface, and
a polymeric layer comprising a thickness from about 25 μm to about 125 μm and disposed over the first primary surface of the redrawn glass element,
wherein the redrawn glass element of the cover element can withstand a pen drop height of greater than 6 cm, wherein the pen drop heights are measured according to Drop Test 1.

2. The cover element of claim 1, wherein the redrawn glass element comprises the ability to withstand a pen drop height of greater than 8 cm.

3. The cover element of claim 2, wherein the redrawn glass element comprises a thickness from about 50 μm to about 75 μm.

4. The cover element of claim 3, wherein the redrawn glass element can withstand a pen drop height of greater than 10 cm.

5. The cover element of claim 3, wherein the redrawn glass element can withstand a pen drop height of greater than 14 cm.

6. The cover element of claim 1, wherein the average surface roughness (Ra) of the redrawn glass element is 0.7 nm or less.

7. The cover element of claim 1, wherein the average surface roughness (Ra) of the redrawn glass element is 0.4 nm or less.

8. The cover element of claim 1, wherein the polymeric layer comprises a polyimide, a polyethylene terephthalate, a polycarbonate or a poly methyl methacrylate.

9. The cover element of claim 1, wherein the polymeric layer is coupled to the redraw glass element by an adhesive, wherein the adhesive is in direct contact with the redrawn glass element and the polymeric layer.

10. The cover element of claim 1, wherein the cover element is further in combination with an electronic device.

11. A method of making a cover element assembly, comprising:
forming a redrawn glass sheet element by redrawing a glass sheet, the redrawn glass sheet element comprising a first primary surface, a second primary surface, a final thickness from about 25 μm to about 125 μm and a final average surface roughness (Ra) equal to 1 nm or less,
disposing a polymeric layer over the first primary surface of the redrawn glass sheet element, the polymeric layer comprising a thickness from about 25 μm to about 125 μm,
wherein the redrawn glass element of the cover element assembly can withstand a pen drop height of greater than 6 cm, wherein the pen drop heights are measured according to Drop Test 1.

12. The method of claim 11, wherein the glass sheet comprises a thickness from about 250 μm to about 750 μm prior to redrawing to form the redrawn glass sheet element.

13. The method of claim 12, wherein the glass sheet is fed into a redraw furnace, the glass sheet is heated in the redrawn furnace to have a viscosity from about 100,000 poise to about 10,000,000 poise and is drawn to the final thickness from about 25 μm to about 125 μm to form the redrawn glass sheet element.

14. The method of claim 13, wherein the average surface roughness (Ra) of the redrawn glass sheet element is from about 0.1 nm to about 0.7 nm.

15. The method of claim 11, wherein the redrawn glass sheet element comprises a thickness from about 50 μm to about 75 μm.

16. The method of claim 11, wherein the redrawn glass sheet element comprises the ability to withstand a pen drop height of greater than 10 cm.

17. The method of claim 11, wherein the redrawn glass sheet element comprises the ability to withstand a pen drop height of about 10 cm to about 16 cm.

18. The method of claim 11, wherein the polymeric layer comprises a polyimide, a polyethylene terephthalate, a polycarbonate or a poly methyl methacrylate.

19. The method of claim 18, wherein the polymeric layer is coupled to the redrawn glass sheet element by an adhesive, wherein the adhesive is in direct contact with the redrawn glass sheet element and the polymeric layer.

20. The method of claim 11, further comprising cutting the redrawn glass sheet element into separate redrawn glass sheet parts prior to disposing the polymeric layer over the primary surface of the redrawn glass sheet element.
